(19) United States
(12) Patent Application Publication
(10) Pub. No.: US 2025/0271812 A1
(43) Pub. Date: Aug. 28, 2025

(54) DEVICE CASE AND TIMEPIECE

(71) Applicant: CASIO COMPUTER CO., LTD., Tokyo (JP)

(72) Inventor: Shigeaki SUGIYAMA, Tokyo (JP)

(73) Assignee: CASIO COMPUTER CO., LTD., Tokyo (JP)

(21) Appl. No.: 19/052,692

(22) Filed: Feb. 13, 2025

(30) Foreign Application Priority Data
Feb. 28, 2024 (JP) 2024-028333

(51) Int. Cl. G04B 37/00; G04B 43/00

(52) U.S. Cl. CPC G04B 37/005; G04B 43/002

(57) ABSTRACT

Disclosed is a device case including: a case main body; a second exterior member attached so as to surround an entire periphery of an upper outer periphery of the case main body; and a first exterior member attached so as to surround at least an upper outer periphery of the second exterior member and the case main body. The second exterior member is formed of a material softer than the first exterior member and interposed between the case main body and the first exterior member along the upper outer periphery of the case main body, and has at least a part of an outer peripheral side surface covered by the first exterior member.

### REFERENCE TO RELATED APPLICATIONS

This application is based upon and claims the benefit of priority from the prior Japanese Patent Application No. 2024-028333, filed on Feb. 28, 2024, the entire contents of which are incorporated herein by reference.

### TECHNICAL FIELD

The present disclosure relates to a device case and a timepiece.

### DESCRIPTION OF RELATED ART

JP 2015-230167 A describes a configuration comprising a body case, a base member arranged to surround the outer peripheral side surface of the body case, and a decorative member attached to surround at least a part of the upper outer periphery of the body case and the base member, wherein the base member is formed from a material softer than the decorative member, a part of which is interposed between the body case and the decorative member along the upper outer periphery of the body case, and at least a part of the outer peripheral side surface is covered by the decorative member. Additionally, on the 3 o'clock and 9 o'clock sides of the upper outer periphery of the body case, a timepiece case is depicted in which, from the inside, a connecting member, a decorative member, and a cover member are arranged in this order.

### SUMMARY OF THE INVENTION

A device case according to an aspect of the present disclosure is a device case comprising:
a case main body;
a second exterior member attached so as to surround an entire periphery of an upper outer periphery of the case main body; and
a first exterior member attached so as to surround at least an upper outer periphery of the second exterior member and the case main body,
   wherein
the second exterior member is formed of a material softer than the first exterior member and interposed between the case main body and the first exterior member along the upper outer periphery of the case main body, and has at least a part of an outer peripheral side surface covered by the first exterior member.

### BRIEF DESCRIPTION OF DRAWINGS

FIG. 1 is a front view of a device case relating to an embodiment;

FIG. 2 is an exploded side view of the device case shown in FIG. 1 as seen from the 3 o'clock side of a timepiece;

FIG. 3 is a side view of the timepiece with the first exterior member removed from the device case shown in FIG. 1, as viewed from the 3 o'clock side;

FIG. 4 is a side view of the device case shown in FIG. 1 as seen from the 3 o'clock side of the timepiece;

FIG. 5 is an exploded perspective view of the device case shown in FIG. 1;

FIG. 6 is a plan view showing a state in which the first exterior member is removed from the device case shown in FIG. 1;

FIG. 7 is a cross-sectional view taken along line VII-VII in FIG. 1; and

FIG. 8 is a cross-sectional view taken along line VIII-VIII in FIG. 1.

### DETAILED DESCRIPTION

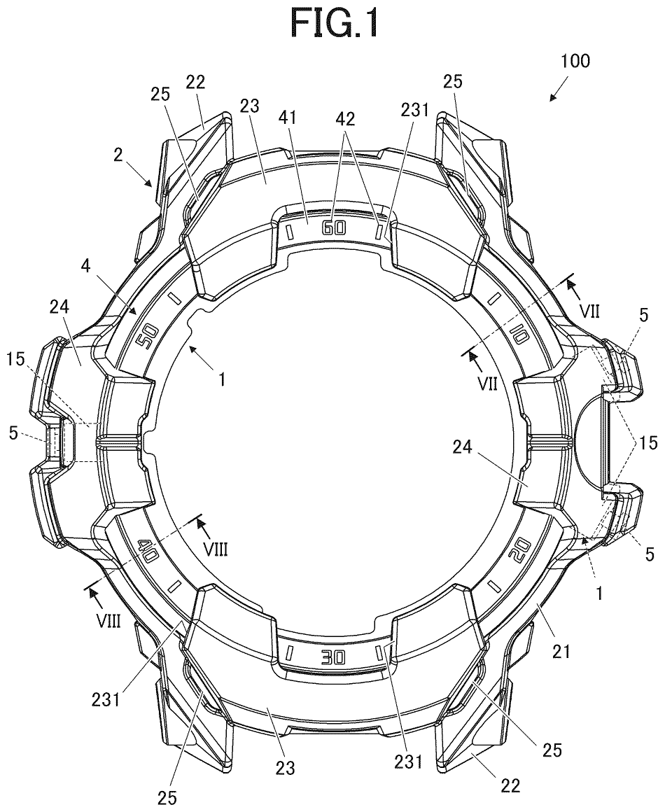

With reference to FIGS. 1 to 8, one embodiment of a device case 100 according to the present disclosure will be described. In this embodiment, the device case 100 is illustrated as a timepiece (wristwatch) case. In FIGS. 1 to 8, illustrations of a band for attaching the timepiece to the wrist, the internal structure of the timepiece, and the like are omitted. In addition, the embodiment illustrates an example in which the device case 100 is approximately circular in a planar view (see FIG. 1, and the like), but the shape of the device case 100 is not limited to this and may be, for example, rectangular or elliptical in a planar view. In addition, the embodiment described below is subject to various limitations that are technically preferable for implementing the present disclosure, but the scope of the present disclosure is not limited to the embodiment and illustrated examples described below.

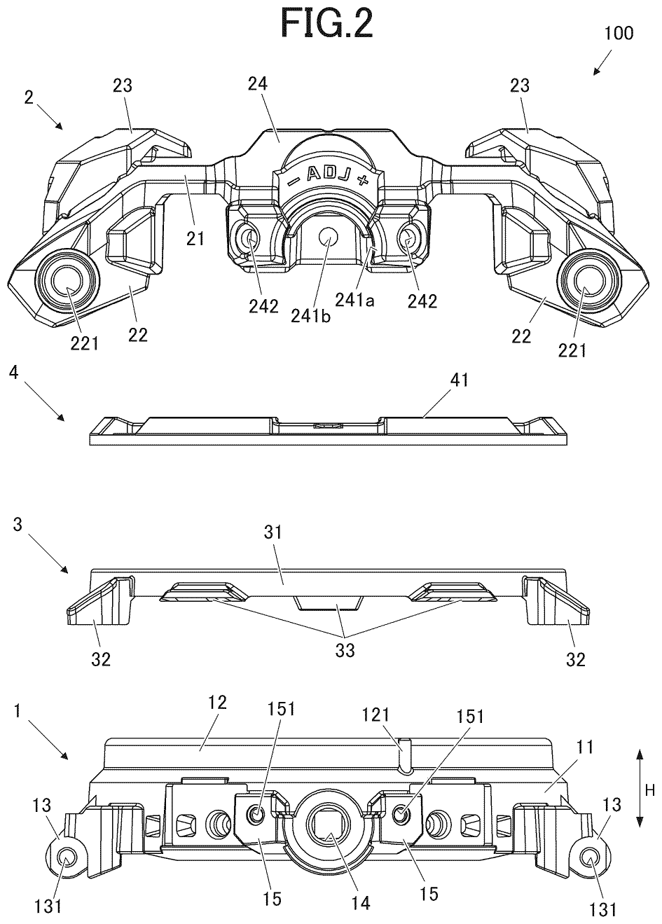

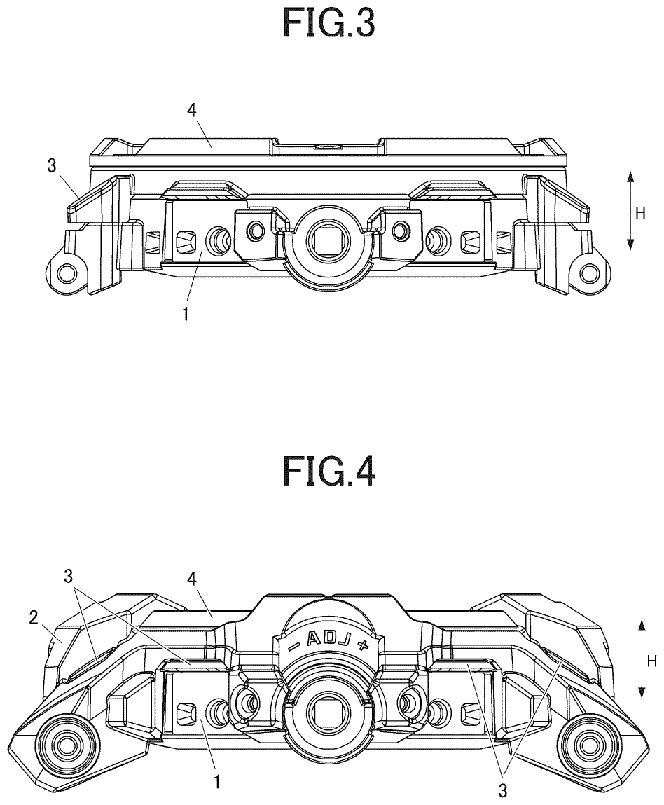

As shown in FIGS. 1 to 5, a device case 100 according to the embodiment includes a case main body 1 and an exterior member. The exterior member includes at least a first exterior member 2 and a second exterior member 3, and in this embodiment further includes a third exterior member 4. At least the first exterior member 2 and the second exterior member 3 are attached so as to surround at least the upper outer periphery of the case main body 1. In the example shown in this embodiment, in the assembled state in which the first exterior member 2, second exterior member 3, and third exterior member 4 are attached to the case main body 1, the exterior members are stacked in the following order on the upper surface side of the case main body 1, as shown in FIGS. 2 and 3, with the second exterior member 3 on top of that, the third exterior member 4 on top of that, and the first exterior member 2 on top of that, with the first exterior member 2 being the outermost exterior member. The configuration of each component will be described below.

JP 2015-230167 A describes a configuration comprising a body case, a base member arranged to surround the outer peripheral side surface of the body case, and a decorative member attached to surround at least a part of the upper outer periphery of the body case and the base member, wherein the base member is formed from a material softer than the decorative member, a part of which is interposed between the body case and the decorative member along the upper outer periphery of the body case, and at least a part of the outer peripheral side surface is covered by the decorative member. Additionally, on the 3 o'clock and 9 o'clock sides of the upper outer periphery of the body case, a timepiece case is depicted in which, from the inside, a connecting member, a decorative member, and a cover member are arranged in this order.

However, in JP 2015-230167 A, a hard connecting member made of highly rigid resin is arranged on the upper outer periphery of the timepiece case, so when the timepiece case receives an impact from the upper outer periphery, the impact is transmitted to the body case and the module inside the body case via the cover member, decorative member, and hard connecting member.

The present disclosure is intended to improve and solve the problems in this situation, and aims to provide a device case and a timepiece that can mitigate external impacts.

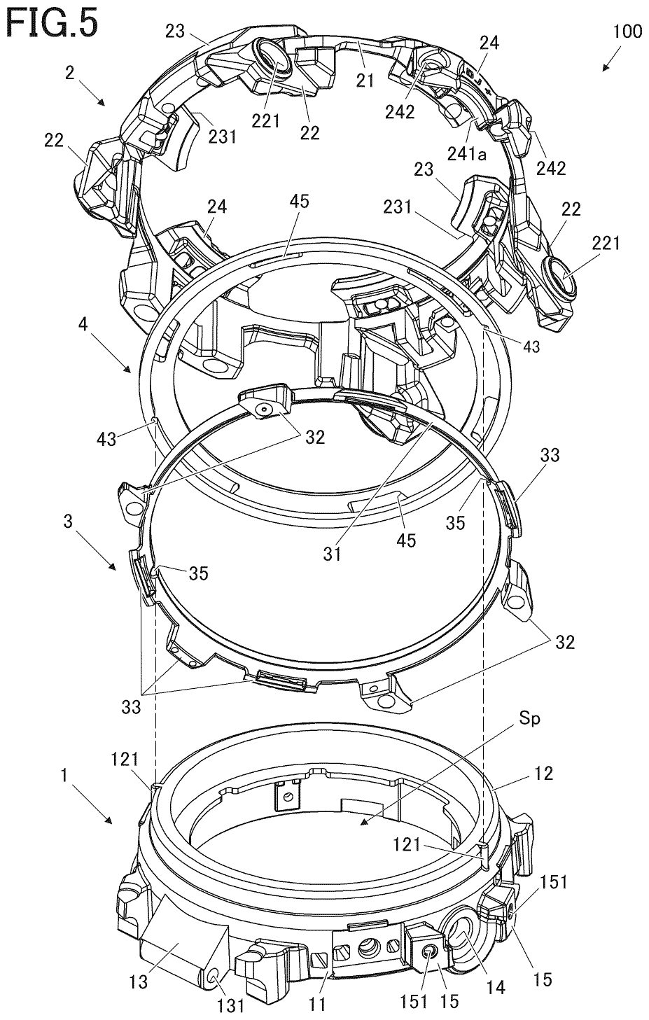

The case main body 1 is formed in a hollow, substantially short columnar shape, and is open at the top and bottom in the thickness direction H (see FIG. 2). The hollow part of the case main body 1 serves as a housing space Sp (see FIG. 5) for housing a module and the like (not shown) therein. Although the specific configuration of the module will not be described in detail, when the device case 100 is a case for an electronic timepiece, the module includes various operating parts of the timepiece, a control part that controls these, a battery, and the like The opening on the upper surface side of the case main body 1 (upper side in the thickness direction H in FIG. 2) is closed by a windshield member (such as a cover crystal) not shown, and the opening on the lower surface side of case main body 1 (lower side in the thickness direction H in FIG. 2) is closed by a back cover member not shown. The case main body 1 is formed of a hard synthetic resin, for example, a super engineering plastic such as polyarylate (PAR) or an engineering plastic such as polyacetal (POM). The materials constituting the case main body 1 and the like are not limited to those exemplified here. For example, various metal materials such as titanium, stainless steel (SUS), and aluminum may be used.

The case main body 1 of this embodiment has a body 11, and the upper part of the body 11 is a cylinder 12. band attachments 13 for connecting a band (not shown) to the case main body 1 are provided on the outer part of the body 11 at positions that correspond to the 6 o'clock and 12 o'clock sides on an analog timepiece. Each band attachment 13 has a through hole formed therethrough that passes through in the 3 o'clock-9 o'clock direction perpendicular to the 6 o'clock-12 o'clock direction. Additionally, on the outer side of the body 11, at positions that would correspond to the 3 o'clock and 9 o'clock sides on an analog timepiece, there are through holes 14 for inserting the shafts of the operating parts such as the crown and push buttons (none of which are shown) inside and out. Furthermore, on the outer sides of the 3 o'clock and 9 o'clock sides of the body 11, screw fastening protrusions 15 each having screw holes 151 are formed so as to protrude laterally (see FIGS. 1 and 2, and the like).

Additionally, case-side locks 121 are formed on the outer peripheral side surface of the cylinder 12 at at least two locations spaced apart in the circumferential direction. In the embodiment, the case-side lock 121 is a convex part (a protruding part that is long in the thickness direction H) that protrudes outward, as shown in FIGS. 3 and 4. The case-side lock 121 is disposed on the outer peripheral side surface of the cylinder 12 at a position asymmetrical in the circumferential direction with respect to the center of the case main body 1. In other words, the case-side locks 121 are provided at positions that do not face each other across the center of the case main body 1. In this embodiment, case-side locks 121 are provided at approximately the 8 o'clock and 2:30 o'clock positions on the timepiece, respectively. The number of case-side locks 121 is not limited to two, but may be three or more. In this case, the case-side locks 121 are not arranged at equal intervals. As described below, the exterior member-side lock 35 of the second exterior member 3 and the exterior member-side lock 43 of the third exterior member 4 are locked to each case-side lock 121. Since the case-side locks 121 are arranged in an asymmetrical position, unless the second exterior member 3 and the third exterior member 4 are arranged in the correct orientation, each exterior member-side lock 35, 43 will not be locked to the case-side lock 121. This prevents mistakes in the assembly direction, such as the second exterior member 3 and the third exterior member 4 being erroneously arranged in the reverse or sideways direction.

Of the exterior members, the first exterior member 2 is formed from a high-hardness (hard) resin material, for example, a super engineering plastic such as polyarylate (PAR) or an engineering plastic such as polyacetal (POM). The material forming the first exterior member 2 is not limited to the examples given here. The first exterior member 2 includes a body 21, band attachment covers 22, protectors 23, button covers 24, and the like. The shapes of the various parts of the first exterior member 2 shown in the figures are merely examples and can be modified as appropriate.

The body 21 is a part formed in an approximately annular shape, and when the first exterior member 2 is attached to the case main body 1, it is positioned so as to surround at least the upper outer periphery of the cylinder 12 of the case main body 1. In an assembled state in which the first exterior member 2 is attached to the case main body 1, a pair of band attachment covers 22 are disposed so as to sandwich the band attachments 13 on both sides on the 6 o'clock and 12 o'clock sides. The band attachment cover 22 is formed with a through hole 221 that communicates with the through hole 131 of the band attachment 13 in the assembled state.

Moreover, the protectors 23 are provided at positions corresponding to the 6 o'clock side and the 12 o'clock side in an assembled state in which the first exterior member 2 is attached to the case main body 1. In the embodiment, the protector 23 is provided between a pair of band attachment covers 22 arranged on the 6 o'clock side and the 12 o'clock side, and is arranged so as to hang from the side part to the upper surface side of the case main body 1. For example, as shown in FIG. 1, cutout parts 231 are suitably formed on the upper surface side of the protectors 23. In this embodiment, a third exterior member 4 is arranged below the first exterior member 2, and engravings 42 such as hour markers and logos applied to a surface 41 of the third exterior member 4 are exposed from the cutout parts 231. The protector 23 is a part that rises upward and is relatively thick, and has some cushioning effect. Gaps 25 are provided between the band attachment covers 22 and the protectors 23, and a part of the components arranged below the protectors 23 (the second exterior member 3 in the embodiment) is exposed to the outside and made visible.

The button covers 24 are provided at positions corresponding to the 3 o'clock and 9 o'clock sides in an assembled state in which the first exterior member 2 is attached to the case main body 1. The button cover 24 is configured to cover and protect at least the upper side of the operating parts such as the crown and the push buttons. In addition, the button cover 24 has a cutout part 241a or a through hole 241b formed in correspondence with the position of the through hole 14 provided in the case main body 1 (see FIGS. 2 and 5), allowing the shaft of the operating part to be inserted therein. Furthermore, the part corresponding to the screw-fastening protrusion 15 provided on the case main body 1 protrudes to cover the screw-fastening protrusion 15, and through hole 242 communicating with the screw hole 151 is formed at the position corresponding to the screw hole 151. The first exterior member 2 and the case main body 1 are fastened to each other at the outer peripheral side surface of the case main body 1 by inserting each fastener such as a screw 5 through the through hole 242 and the screw hole 151. The button cover 24 is a relatively thick part that rises upward to about the same height as the protector 23, and has some cushioning effect.

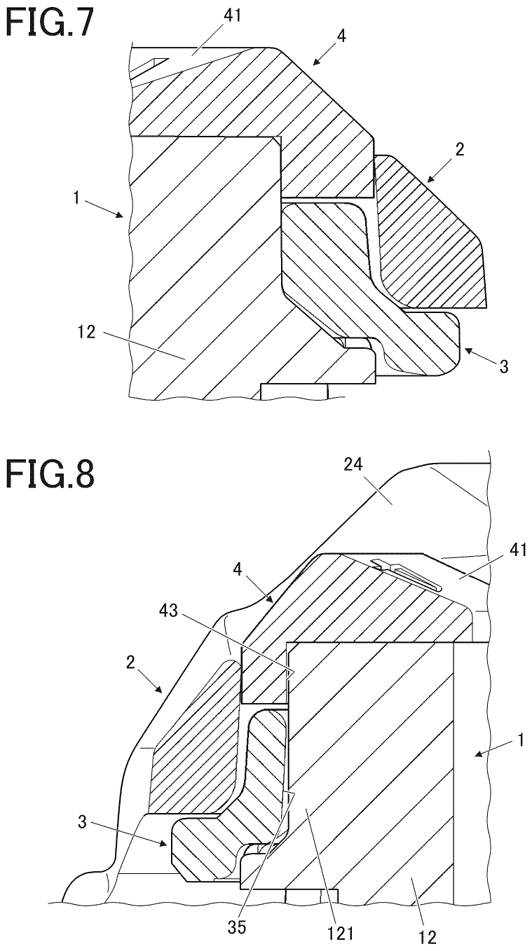

Of the exterior members, the second exterior member 3 is arranged so as to be interposed between the case main body 1 and the first exterior member 2 along the upper outer periphery of the case main body 1 (in the embodiment, the outer periphery of the cylinder 12). That is, as shown in the cross section of FIG. 5, the second exterior member 3 is disposed on the inside closer to the case main body 1 than the first exterior member 2, thereby preventing the first exterior member 2 from coming into direct contact with the case main body 1. In FIG. 7, illustration of the case main body 1 is omitted. The second exterior member 3 is made of a softer material than the first exterior member.

The first exterior member 2 of this embodiment is formed from a resin material with high hardness (hard) as described above, and the second exterior member 3 is formed from a resin material with a lower hardness (softer) than the first exterior member. Specifically, for example, the second exterior member 3 is formed from various urethane resins. In addition, the second exterior member 3 only needs to be made of a soft material with a high cushioning effect, and the material from which the second exterior member 3 is made is not limited to urethane resin. The second exterior member 3 may be formed from a soft gel-like material such as αGEL (registered trademark) whose main ingredient is silicone.

The second exterior member 3 made of such a soft material is disposed on the inside closest to the case main body 1 among the exterior members surrounding the case main body 1, thereby effectively cushioning any impact received from the outside. At least a part of the outer peripheral side surface of the second exterior member 3 is covered by the first exterior member 2. As a result, even if the second exterior member 3 is made of a soft material, it is not easily turned up or twisted, and the appearance is maintained. The second exterior member 3 includes a body 31, band attachment buffers 32, and protrusions 33 that protrude from the body 31 as appropriate. The shapes of the various parts of the second exterior member 3 shown in the figures are merely examples and can be modified as appropriate.

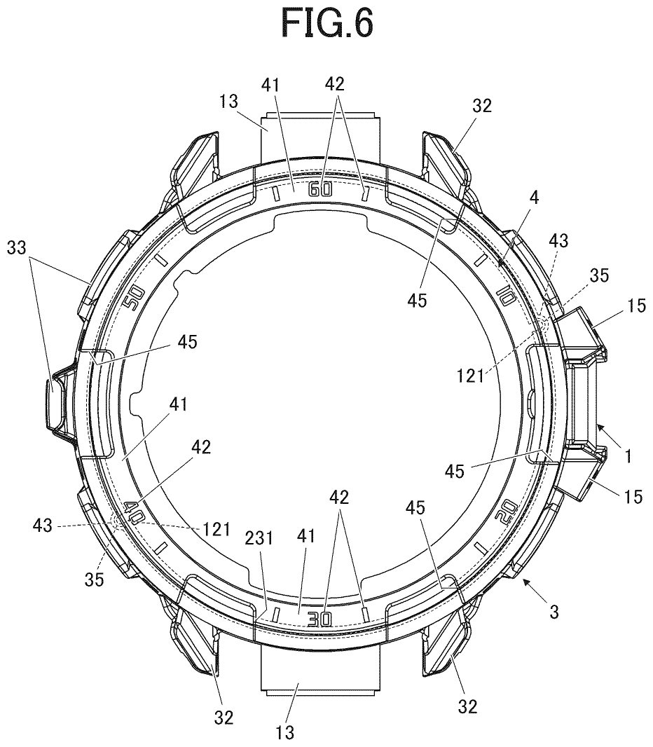

The body 31 is a part formed in an approximately annular shape, and when the second exterior member 3 is attached to the case main body 1, it is positioned so as to surround at least the outer periphery of the upper part of the cylinder 12 of the case main body 1. As shown in FIGS. 5 and 6, exterior member-side locks 35 are provided on the inner peripheral side surface of the body 31 of the second exterior member 3 at the positions corresponding to the case-side locks 121 in an assembled state in which the second exterior member 3 is attached to the case main body 1. The exterior member-side locks 35 are locked to the case-side locks 121. In this embodiment, the exterior member-side lock 35 is a recessed part having a shape corresponding to the case-side lock 121 which is a convex part.

The band attachment buffer 32 is a protrusion that is interposed between the band attachment 13 of the case main body 1 and the band attachment cover 22 of the first exterior member 2 in an assembled state in which the second exterior member 3 is attached to the case main body 1. When the band attachment buffer 32 is disposed between the case main body 1 and the first exterior member 2, a part of the band attachment buffer 32 is exposed from the gap 25 of the first exterior member 2 to provide a contrasting color and also function as a decorative part. The protrusions 33 are disposed on the 3 o'clock and 9 o'clock sides of the timepiece and are appropriately interposed between the button cover 24 and the case main body 1.

The third exterior member 4 is an exterior member at least a part of which is disposed between the first exterior member 2 and the second exterior member 3. The third exterior member 4 is formed from a metal material such as stainless steel (SUS), aluminum, or titanium. The third exterior member 4 may be formed from various metallic materials other than the above-mentioned metals, or may be formed from materials other than metals, such as glass or ceramic. The third exterior member 4 is formed in an approximately annular shape, and when the third exterior member 4 is attached to the case main body 1, it is positioned so as to surround at least the outer periphery of the upper part of the cylinder 12 of the case main body 1.

On the surface 41 of the third exterior member 4, engravings 42 of hour markers, logos, and the like are applied by laser processing or the like. The first exterior member 2 is positioned above the third exterior member 4, and as shown in FIG. 1, the part with the engraving 42 is exposed from the cutout part 231 of the first exterior member 2, forming the upper appearance of the device case 100. As shown in FIG. 7, the upper surface of the third exterior member 4 is not flat but has a mountain shape, but as shown in FIG. 8, for example, even the highest part of the third exterior member 4 is lower than the button cover 24 (the same is true for the protector 23) of the first exterior member 2. This prevents the third exterior member 4 from being scratched or scraped and damaged.

As shown in FIG. 3, an exterior member-side lock 43 is provided on the inner peripheral side surface of the third exterior member 4 at a position corresponding to the case-side lock 121 in an assembled state in which the third exterior member 4 is attached to the case main body 1. The exterior member-side lock 43 is locked to the case-side lock 121. In this embodiment, the exterior member-side lock 43 is a recessed part having a shape corresponding to the case-side lock 121 which is a convex part. FIG. 6 shows the overlap of the case main body 1, second exterior member 3, and third exterior member 4 in an assembled state with the first exterior member 2 removed, and the case-side locks 121 and the exterior member-side locks 35, 43 that are locked to the case-side lock 121 are shown in dashed lines. As shown in FIGS. 6 and 8, in the assembled state, the exterior member-side lock 35 of the second exterior member 3 and the exterior member-side lock 43 of the third exterior member 4 are locked to the case-side lock 121 of the case main body 1 in an overlapping manner. Next, the operation of the device case 100 of this embodiment will be described. When assembling the device case 100 in this embodiment, the module is housed in the case main body 1, and the opening on the visible side is closed with a windshield member, and the opening on the non-visible side is closed with a back cover member.

Then, as shown in FIGS. 2 and 5, the second exterior member 3 is disposed so as to surround the outer periphery of the cylinder 12 which is the upper part of the body 11 of the case main body 1. Specifically, the substantially annular body 31 of the second exterior member 3 is attached to the cylinder 12 from above the case main body 1. At this time, the circumferential orientation (position) of the second exterior member 3 is adjusted so that the exterior member-side lock 35 of the second exterior member 3 is locked to the case-side lock 121 of the case main body 1.

Next, the substantially annular third exterior member 4 is attached from above the cylinder 12 to which the second exterior member 3 is attached, with the surface 41 facing up. At this time, the circumferential orientation (position) of the third exterior member 4 is adjusted so that the exterior member-side lock 43 of the third exterior member 4 is locked to the case-side lock 121 of the case main body 1. As a result, as shown in FIGS. 6 and 8, the exterior member-side lock 35 of the second exterior member 3 and the exterior member-side lock 43 of the third exterior member 4 are locked to the case-side lock 121 of the case main body 1, and the orientation of the second exterior member 3 and the third exterior member 4 is restricted so that they cannot rotate freely in the circumferential direction relative to the case main body 1.

As shown in FIGS. 2 and 5, when the case main body 1, the second exterior member 3, and the third exterior member 4 are stacked in this order, the first exterior member 2 is further attached from above. The first exterior member 2 is oriented such that the band attachment cover 22 is disposed on the 6 o'clock-12 o'clock side where the band attachment 13 is provided on the case main body 1, and the button cover 24 is disposed on the 3 o'clock-9 o'clock side. As a result, when assembled, the protector 23 and a part (upper surface side) of the button cover 24 cover at least a part of the upper surface (surface 41) of the second exterior member 3 and the third exterior member 4 arranged above it.

At this time, the engravings 42 on the surface 41 of the third exterior member 4 are appropriately exposed from the cutout parts 231 of the protectors 23, and become visible from the outside. In addition, in the assembled state, the band attachment buffers 32 of the second exterior member 3 is disposed below the band attachment covers 22 of the first exterior member 2, preventing the first exterior member 2 from coming into direct contact with the case main body 1. In addition, a part of the second exterior member 3 is exposed from the gaps 25, providing a decorative effect as an accent color. Furthermore, by placing the first exterior member 2 on the outermost of the device case 100, the second exterior member 3 cannot be directly touched from the outside with fingers, and the like, and the second exterior member 3 is prevented from being turned over or deformed by being caught on fingertips, nails, and the like.

In this way, when each exterior member (that is, the second exterior member 3, the third exterior member 4, and the first exterior member 2) is attached to the upper outer periphery of the case main body 1, screws 5 are inserted into the multiple through holes 242 (in FIG. 1, and the like, two locations on the 3 o'clock side and one location on the 9 o'clock side) formed in the button cover 24 of the first exterior member 2 and inserted through the screw holes 151 of the case main body 1, and the first exterior member 2 and case main body 1 are fastened to the outer peripheral side surface of the case main body 1 by the screws 5. In this way, the device case 100 is completed.

As shown in FIG. 3, neither the third exterior member 4 nor the second exterior member 3 is fixed by a screw. The second exterior member 3 has four band attachment buffers 32, which are supported by four legs of the case main body 1. Also, as shown in FIG. 4, the top first exterior member 2 covers the third exterior member 4 and second exterior member 3 located below, and is secured to the case main body 1 by screws 5 (see FIG. 1) on the outer peripheral side surface of the first exterior member 2 from a position lower than the third exterior member 4 and the second exterior member 3.

If a timepiece equipped with a device case 100 configured in this manner is dropped, the first exterior member 2 located on the outermost side first receives an impact from the outside, and the impact is then transmitted to the third exterior member 4 and second exterior member 3 located inside the first exterior member 2. The shock is absorbed and mitigated by the second exterior member 3 which is made of a soft material having a cushioning effect, such as urethane resin. As a result, large impacts are not transmitted to the case main body 1, which is located further inside than the second exterior member 3, and precision equipment such as modules housed in the housing space Sp inside the case main body 1 is protected from the impacts, preventing damage and malfunction.

As described above, the device case 100 of this embodiment comprises a case main body 1, a second exterior member 3 attached so as to surround the entire upper outer periphery of the case main body 1, and a first exterior member 2 attached so as to surround at least the upper outer periphery of the case main body and the second exterior member 3, the second exterior member 3 being formed of a softer material than the first exterior member 2 and being interposed between the case main body 1 and the first exterior member 2 along the upper outer periphery of the case main body 1, with at least a part of the outer peripheral side surface being covered by the first exterior member 2. In this way, in this embodiment, even if the hard first exterior member 2 is thin, a second exterior member 3 made of a material softer than the first exterior member 2 is provided on the inner side of the first exterior member 2.

Therefore, if an impact occurs from the side, the impact can be mitigated. This allows the first exterior member 2 to be made of a hard and thin member, and makes it possible to maintain high impact resistance even when the overall size of the device case 100 is reduced. Furthermore, because the first exterior member 2 is hard, it cannot be easily turned over, deformed, or displaced by a user, and the like, and the quality of the appearance of the device case 100 can be maintained. In the embodiment, the first exterior member 2 and the case main body 1 are fastened together by a fastener on the outer peripheral side surface of the case main body. As a result, fasteners such as screws 5 are not visible on the top surface of the device case 100, which tends to be noticeable from an external perspective, and a highly aesthetically pleasing external appearance can be achieved.

In addition, at least the upper part of the case main body 1 of the embodiment is a cylinder 12, and convex case-side locks 121 are formed on the outer peripheral side surface of the cylinder 12 at at least two locations spaced apart in the circumferential direction, and a recessed exterior member-side lock 35 which is locked to the case-side lock 121 is provided on the inner peripheral side surface of the second exterior member 3 at a position corresponding to the case-side lock 121. As a result, by fitting the case-side lock 121 and the exterior member-side lock 35 together, rotation is prevented, the second exterior member 3 can be correctly positioned, and assembly can be easily performed. In addition, the second exterior member 3, which is made of a soft material, can be prevented from twisting or shifting.

In addition, in the embodiment, the case-side lock 121 and the exterior member-side lock 35 are arranged on the outer peripheral side surface of the cylinder 12 at asymmetric positions in the circumferential direction relative to the center of the cylinder 12 of the case main body 1. Therefore, if the fitting direction is incorrect, the exterior member-side lock 35 will not fit, thereby preventing assembly errors. Although not shown, the parting member also has a similar structure.

In the embodiment, the first exterior member 2 is formed from a resin material having a high hardness, and the second exterior member 3 is formed from a resin material having a lower hardness than the first exterior member 2. In this way, since both the first exterior member 2 and the second exterior member 3 are formed from a resin material, it is possible to reduce weight, and the first exterior member 2, which is formed from a hard material, can be expected to have some impact absorption effect in the thick parts.

In addition, in the embodiment, the exterior member includes a third exterior member 4, at least a part of which is disposed between the first exterior member 2 and the second exterior member 3 and formed of a metal material. By using metal components for the exterior member, it is possible to add a touch of luxury and elegance. Furthermore, in the case of resin material components, if it is desired to add letters or the like, a mold must be created, but in the case of metal components, this can be achieved by engraving 42 using laser processing to add letters, numbers, symbols, and the like, such as hour markers or logos. This eliminates the need to change the mold, and makes it easy to deal with minor model changes, such as changing the logo.

Further, the case main body 1 of the embodiment has a housing space Sp inside in which the module is housed. Even when a module including precision parts and the like is housed in the case main body 1, the shock-resistant structure prevents shock from being transmitted to the inside of the case main body 1, thereby preventing damage to the module and the like.

Although the embodiment of the present disclosure has been described above, it goes without saying that the present disclosure is not limited to the above-mentioned embodiment, and various modifications are possible without departing from the spirit of the present disclosure.

For example, in the above example, the exterior member attached to the case main body 1 has a three-layer structure in which a first exterior member 2, a second exterior member 3, and a third exterior member 4 are stacked in order, but the device case is not limited to an exterior member composed of three layers. For example, the exterior member may have a two-layer structure of a first exterior member 2 formed from a hard resin material or the like and a second exterior member 3 formed from a softer resin material than the first exterior member 2. In this case as well, the second exterior member 3 is arranged on the inside closer to the case main body 1, and the first exterior member is arranged on the outside thereof. This effectively reduces or prevents external impact from being transmitted to the case main body 1.

In addition, in the above embodiment, an example is given of the exterior member having a three-layer structure, in which the first exterior member 2 and the second exterior member 3 are formed from a resin material, and the third exterior member 4 is formed from a metal material or the like, but the configuration of the exterior member is not limited to this. For example, only the second exterior member 3 may be formed from a resin material (a soft resin material such as urethane resin), and the first exterior member 2 and the third exterior member 4 may both be formed from a metal material or the like. If the first exterior member 2 is formed from a metal material, the outermost first exterior member 2 can be easily engraved by laser processing or the like, making it easy to change the appearance design, such as the logo.

In addition, in the above embodiment, an example is given in which the case-side lock 121 of the case main body 1 is a convex part, and the exterior member-side lock 35 of the second exterior member 3 and the exterior member-side lock 43 of the third exterior member 4 that lock to it are recessed parts, but the case-side lock 121 and the exterior member-side locks 35, 43 only need to be shaped to fit into each other, and are not limited to the above shapes. For example, the case-side lock 121 of the case main body 1 may be a recessed part, and the exterior member-side lock 35 of the second exterior member 3 and the exterior member-side lock 43 of the third exterior member 4 that are locked to it may be convex parts having a shape corresponding to the case-side lock 121.

In addition, in each of the above embodiments, the device case 100 is exemplified as a case for a timepiece (wristwatch), but the devices to which the device case 100 can be applied are not limited to timepieces, and the device case 100 of this embodiment may be widely applied to device cases that house parts inside the case main body 1 that are at risk of being damaged by impact. For example, the present disclosure can be widely applied to electronic devices such as various smart watches and sports watches, as well as wearable devices that acquire biometric information such as heart rate and blood flow information in addition to time.

In addition, the specific contents such as the configuration, processing arrangement, order, and numerical values shown in the above embodiment can be changed as appropriate without departing from the spirit of this disclosure. Furthermore, the scope of the present disclosure is not limited to the above embodiment, but includes the scope of the invention described in the claims and its equivalents.

1. A device case comprising:
a case main body;
a second exterior member attached so as to surround an entire periphery of an upper outer periphery of the case main body; and
a first exterior member attached so as to surround at least an upper outer periphery of the second exterior member and the case main body,
wherein
the second exterior member is formed of a material softer than the first exterior member and interposed between the case main body and the first exterior member along the upper outer periphery of the case main body, and has at least a part of an outer peripheral side surface covered by the first exterior member.

2. The device case according to claim 1, wherein
the first exterior member and the case main body are fastened to each other by a fastener at a position lower than the second exterior member on an outer peripheral side surface of the case main body.

3. The device case according to claim 1, wherein
at least an upper part of the case main body is a cylinder, and
the cylinder has an outer peripheral side surface on which case-side locks are formed at at least two locations spaced apart in a circumferential direction.

4. The device case according to claim 2, wherein
at least an upper part of the case main body is a cylinder, and
the cylinder has an outer peripheral side surface on which case-side locks are formed at at least two locations spaced apart in a circumferential direction.

5. The device case according to claim 3, wherein
exterior member-side locks that are locked to the case-side locks are provided at positions corresponding to the case-side locks on an inner peripheral side surface of the second exterior member.

6. The device case according to claim 4, wherein
exterior member-side locks that are locked to the case-side locks are provided at positions corresponding to the case-side locks on an inner peripheral side surface of the second exterior member.

7. The device case according to claim 5, wherein
the case-side locks are disposed on the outer peripheral side surface of the cylinder at positions asymmetrical in the circumferential direction with respect to a center of the case main body.

8. The device case according to claim 6, wherein
the case-side locks are disposed on the outer peripheral side surface of the cylinder at positions asymmetrical in the circumferential direction with respect to a center of the case main body.

9. The device case according to claim 1, wherein
the first exterior member is formed of a resin material having a high hardness, and the second exterior member is formed of a resin material having a lower hardness than the first exterior member.

10. The device case according to claim 2, wherein
the first exterior member is formed of a resin material having a high hardness, and the second exterior member is formed of a resin material having a lower hardness than the first exterior member.

11. The device case according to claim 5, wherein
the first exterior member is formed of a resin material having a high hardness, and the second exterior member is formed of a resin material having a lower hardness than the first exterior member.

12. The device case according to claim 6, wherein
the first exterior member is formed of a resin material having a high hardness, and the second exterior member is formed of a resin material having a lower hardness than the first exterior member.

13. The device case according to claim 1, further comprising a third exterior member, at least a part of which is disposed between the first exterior member and the second exterior member and which is formed of a metal material.

14. The device case according to claim 2, further comprising a third exterior member, at least a part of which is disposed between the first exterior member and the second exterior member and which is formed of a metal material.

15. The device case according to claim 5, further comprising a third exterior member, at least a part of which is disposed between the first exterior member and the second exterior member and which is formed of a metal material.

16. The device case according to claim 6, further comprising a third exterior member, at least a part of which is disposed between the first exterior member and the second exterior member and which is formed of a metal material.

17. The device case according to claim 13, wherein
the first exterior member covers at least a part of the second exterior member and a part of the third exterior member and is fastened to the case main body by a fastener at a position lower than the second exterior member and the third exterior member on an outer peripheral side surface of the first exterior member.

18. The device case according to claim 14, wherein
the first exterior member covers at least a part of the second exterior member and a part of the third exterior member and is fastened to the case main body by a fastener at a position lower than the second exterior member and the third exterior member on an outer peripheral side surface of the first exterior member.

19. The device case according to claim 1, wherein
the case main body includes a housing space in which a module is housed.

20. A timepiece comprising the device case according to claim 1.
